(19) United States
(12) Patent Application Publication
(10) Pub. No.: US 2021/0201281 A1
(43) Pub. Date: Jul. 1, 2021

(54) SYSTEM AND METHOD FOR CHARGING MEANS OF TRANSPORT

(71) Applicant: APACE RESOURCES AS, OSLO (NO)

(72) Inventors: Bjørn Kjetil MØLMANN, Lillestrøm (NO); Harald FURU, Oslo (NO)

(21) Appl. No.: 16/066,765

(22) PCT Filed: Dec. 29, 2016
(86) PCT No.: PCT/NO2016/050272

§ 371 Date: Jun. 28, 2018

(30) Foreign Application Priority Data
Jan. 4, 2016 (NO) 20160003

(51) Int. Cl. G06Q 20/14; G07B 15/06; G07C 5/08; G01C 22/00; G01M 15/10; G01S 19/01

(52) U.S. Cl. CPC G06Q 20/145; G07B 15/063; G07C 5/08; G06Q 10/20; G01M 15/102; G01S 19/01; G06Q 2220/00; G01C 22/00

(57) ABSTRACT

A system (100) for charging fees for a vehicle (10) comprises a central system (101) and a secure device (110) mounted in the vehicle (10). The secure device (110) receives, process and stores fee data and provide authentication of origin and integrity to all output fee data by means of a digital signature and/or a secure connection, e.g. to the central system (101) over a public network (14, 140) or to a terminal (112). Input data to the secure device (110) may be provided by an emission sensor (120) for measuring concentrations of soot, CO, CO₂, NOx and/or SOx in the exhaust of the vehicle (10), an odometer (121), a positioning system (13, 30) and/or fee rates provided from the central system (101) over the public network (14, 40). A method for removing unfounded suspicion from parties with interests in the system is also proposed.

### BACKGROUND

The present invention concerns a system and method for charging fees for a vehicle.

Globally, there is an increased public focus on climatic changes, especially emission of carbon from fossil hydrocarbons in CO₂, which generally is regarded as a major contributor to the greenhouse effect. Locally, people in many urban areas are concerned about air polluted by dust, soot and other particles. There are also concerns related to emission of other gases, of which nitrogen oxides (NOx) and sulphur oxides (SOx) are of particular interest.

In some countries, the authorities impose fees to discourage an undesired public behaviour, e.g. reduce traffic at certain times in certain areas in order to improve local air quality. The fees may be charged on some vehicles, e.g. private cars in some areas during certain periods, while other vehicles, e.g. ambulances, police cars, fire trucks etc., are not charged any fee at any time. Some vehicles are needed for transport of goods, and may be eligible for different fees than those applied to private cars. Thus, a system for charging fees on vehicles should enable different fees depending on a class of vehicle, e.g. private car, public utility vehicle and private utility vehicle. Moreover, the system should preferably be able to charge fees depending on area and time.

Alternatively or in addition, certain fees may be reduced to encourage desired behaviour. For example, Norwegian authorities have reduced taxes on electric cars, and electric cars are allowed to pass certain toll stations free of charge. These fee reductions, combined with other benefits, has resulted in a significant increase in sales of electric private cars, and a corresponding decrease in emission of soot, CO₂, NOx and SOx. In general, there is a need or desire to distinguish between types of vehicle within a certain class, e.g. depending on emission. For example, private cars might be subdivided into zero-emission, low-emission, medium-emission etc. according to predefined criteria. Similar distinctions could apply to private or public utility vehicles in other classes, e.g. buses or lorries.

As illustrated by the examples above, many authorities recognize the environmental concerns. Still, some large companies and authorities lag behind the informed public.

A large German car manufacturer recently provided a first example. The company admitted to cheating on emission tests for diesel engines, which immediately caused a plunge in second-hand prices for the affected brands and in the company's share price. In addition, the responsible authorities may have lost credibility as they apparently allowed tests that were simple to circumvent, thereby favouring a large company over the informed public.

Norwegian politicians have provided a second example. They decided to drop diesel fees for environmental reasons and then increased them a few years later. The main reasons for the increase were local emission of NOx and the fact that crops for biodiesel was favoured over crops for people in some countries. The informed public was well aware of both these factors when the decision to encourage use of biodiesel was made, and hence did not expect the subsequent increase. The result was a drop in second-hand prices on diesel cars, and a drop in confidence in the authorities.

The two previous examples illustrate that a fraction of the population may be willing to pay for environmental benefits, and that this fraction's willingness to pay may be reduced by fraudulent companies and distrust in the authorities. Regardless of who is responsible and whether the distrust is well founded or not, reduced public confidence is a problem for responsible authorities, as any distrust may reduce the effect of future attempts to change general public behaviour, and possibly also reduce public revenues.

A first objective of the present invention is to provide easily verifiable basis for transportation fees. This allows a motorist to see what it receives in return for its payments and efforts, for example reduced fees in return for investments in a low-emission vehicle, fees based on use of the vehicle in certain areas at certain times, etc. A system that meets this objective is likely to be considered fair by the general public. For responsible authorities, a system taking many parameters into account allow for a wider differentiation of fees, and is hence a powerful tool for “nudging” citizens toward a desired behaviour.

Another objective of the present invention is to provide a system that is easy to install and maintain. Revenue generated from fees have greater effect if they reduce other fees in the system than if they are spent on administration to collect fees.

Yet another objective is to provide a secure system. This includes providing reliable data with a known source of origin and preventing any unauthorised party from reading or modifying the data.

A general objective of the present invention is to provide a system for charging fees that can be trusted and perceived as fair by the general public, authorities and other parties while retaining the benefits from prior art.

### SUMMARY OF THE INVENTION

These and other objectives and benefits are achieved by a system according to claim 1 and a method according to claim 12. Further features and benefits appear in the dependent claims.

In a first aspect, the invention concerns a system for charging fees for a vehicle. The system comprises a central system. A secure device is mounted in the vehicle and is configured to receive, process and store fee data as well as to provide nonrepudiation for all output fee data.

The fee data includes any fee related data, e.g. a registration number, size and type of vehicle etc. Some fee data may comprise a fee rate multiplied by a usage parameter, e.g. a fee rate for studded tires multiplied by a mileage, a fee rate of zero for emergency vehicles or separate fee rates for emission of fossil carbon, NOx or SOx multiplied by an actual emission of the respective substance.

The associated fee is preferably computed in the secure device. Alternatively, the secure device might forward usage parameters to the central system, which accordingly would have to be larger and more expensive to handle an increased amount of usage data and combine the usage data with their corresponding fee rates. Either way, the secure device must process data.

In digital security and the present invention, nonrepudiation includes the ability to prove the integrity and origin of data, and an authentication that can be asserted with high assurance. In particular, a central computer system should rely on current cryptography for verifying origin of data and preventing unauthorised altering of data in transit from the secure device. In a general system involving a vehicle owner and an administration and accounting systems for charging and collecting fees, nonrepudiation additionally includes associating the vehicle owner with fee data from the secure device and administrative measures for removing unfounded suspicion from the vehicle owner, a vehicle manufacturer and authorities responsible for charging the fees.

As current technology for secure systems are based on public key cryptography, the mandatory nonrepudiation also implies that there is no need for a register of keys in the central system, and hence neither an associated cost for distributing secret keys over secure channels nor a cost for protecting a central register of keys.

The system preferably comprises a terminal suitable for verifying and approving fee data. The terminal may be a console mounted in the vehicle, a smart phone, tablet, PC or any other device able to establish a secure connection to the secure device or to a secure website.

In one embodiment, a vehicle owner may review a detailed list downloaded from the secure device to the terminal and submit a summary to the central system. The terminal may contain software for comparison with historic data, trend analysis etc. In an alternative embodiment, the vehicle owner may review detailed fee data on a secure website. In the latter embodiment, the central system might delete private data as soon as the associated fees are charged. Both of these embodiments should comply with most privacy regulations.

The system may further comprise an emission sensor placed in the exhaust of the vehicle and configured to provide real-time emission data to the secure device. The emission sensor is not relevant for zero-emission vehicles, e.g. vehicles powered by electric power supplied from a battery or from hydrogen through a fuel cell. If present, the emission sensor may provide emission data selected from a group comprising concentration of soot, carbon oxides, nitrogen oxides and sulphur oxides, all of which pollute locally and globally. Preferably, the concentrations are measured, as they do not depend on how the vehicle is used, e.g. frequent stops and starts vs. cruising at near constant speed.

An odometer for measuring mileage is present in all road vehicles, and can thus provide fee related usage data to the secure device. The mileage may be multiplied by an appropriate fee rate to produce a fee.

Preferably, the system comprises a PS-receiver for providing positioning data to the secure device. The PS-receiver typically receives data from a global satellite based positioning system such as NAVSTAR or GLONASS. In addition or alternatively, regional positioning or navigation systems such as LORAN-C may provide signals for the PS-receiver.

The purpose of the PS-receiver is to provide the secure device with positioning data for charging purposes, e.g. when the vehicle enters and leaves an area with a different fee rate.

The proposed system may further comprise an automatic toll station for recording a time at which the vehicle passes. In other words, an existing toll system may be extended with the system according to the invention, thereby adding the possibility of usage based fees to the fixed fees associated with current toll systems.

In some embodiments, the automatic toll station may recognise a registration number from a license plate attached to the vehicle. This feature provides an additional link between the vehicle and the secure device and enhances nonrepudiation in the general system. 100.

The proposed system may comprise a radio transceiver for connecting the secure device to a public network. The transceiver permits transfer of fee data directly to the central system and updating fee rates directly from the central system. Alternatively, a terminal associated with the vehicle owner may submit fee data to the central system and a terminal for maintenance may update the fee rates.

The secure device may be configured to encrypt fee data. Encryption ensures confidentiality, e.g. to prevent misuse of private information such as the location of a certain vehicle at a certain time.

The central system preferably comprises a blacklist of lost or stolen security devices. This enhances nonrepudiation in a general sense in the general system 100, i.e. the system including the vehicle owner and an administration for charging and collecting fees.

In a second aspect, the invention concerns a method for charging fees for a vehicle using the system according to the first aspect of the invention and comprising the step of assigning installation and maintenance of the secure device and associated sub systems to a service centre for vehicle maintenance.

One purpose is to avoid unnecessary cost, as existing service centres may install and maintain the proposed system during normal service or mandatory vehicle controls. An additional purpose is to increase public confidence in the system by making the risk and effort required to break the system obvious. The number of service centres increases the probability for at least one of them reports an attempt of manipulation to the press or in social media.

A trusted third party, i.e. a person or company with no interest in the fees charged, may be accredited for calibrating accurate instruments for measuring emission in the exhaust of a vehicle. Such instruments are already in place at many service centres.

The service centre may in turn calibrate the emission sensor in the proposed system against such an instrument. This secondary calibration adjusts output values from the emission sensor to accurate values provided by the instrument. As indicated above, the output values preferably represent real-time concentrations of chemical substances, and are hence independent of how the vehicle is used, e.g. the time spent stopping and starting in heavy traffic compared to the time spent cruising at steady speed. The adjustment may be performed by altering a rate or similar in the secure device by means of a terminal in the service centre.

A trusted third party is a common measure to remove unfounded suspicion from interested parties, here the vehicle owner, the vehicle manufacturer and the authorities responsible for charging the fees. The proposed method has a similar purpose.

### BRIEF DESCRIPTION OF THE DRAWINGS

The invention will be explained with reference to exemplary embodiments and the accompanying drawings, in which

FIG. 1 illustrates a system according to the invention and

FIG. 2 illustrates a method according to the invention.

### DETAILED DESCRIPTION OF PREFERRED EMBODIMENTS

The drawings are schematic and not to scale. For ease of understanding, numerous details known to the skilled person are omitted from the drawings and the following description.

In the following, “security” and “secure” involves confidentiality, nonrepudiation and availability, in particular in a computer system. Availability is generally ensured by multiple paths between a sender and a recipient and/or by a possibility for delivering a message at any time within a predefined period. The proposed system offer both alternatives.

Until 1973, a sender and a recipient had to possess identical keys to encrypt messages. Such systems are known as symmetric key systems, and were expensive due to the need for protecting numerous secret keys in a central system and trusted couriers for distributing the keys. In 1973, the British GCHQ developed public key cryptography (PKC) to reduce these costs. This development was kept secret until 1997, so the development of PKC is often attributed to Rivest, Shamir and Adleman who published their RSA-algorithm in 1977. PKC enables anyone to encrypt a message with a recipient's public key, but only the recipient can decrypt the message using a private key.

Encryption is used to keep a message or data confidential. For example, the fact that a certain vehicle was in a certain area at a certain time may indicate an extramarital affair. Such private data should at least be encrypted in transit over a public network, thereby making them unreadable for an eavesdropper or a malicious party.

However, even in allegedly secure organisations such information may be used for other purposes than intended, cf. the Petraeus scandal in 2012 where an internal leak caused the resignation of the Director of CIA and were followed by speculations of who had motive to leak. A safer approach is to keep private information private, e.g. just transmit a summary for charging purposes. Any local state-level desire for collecting positioning data for other purposes, typically monitoring citizens for alleged anti-terror purposes, should be balanced against a foreign state-level adversary's corresponding opportunity to acquire and analyse the data for its own purposes.

In the proposed system, digital nonrepudiation includes integrity, i.e. that fee data remain unaltered regardless of their path through a public network. Nonrepudiation is typically achieved by public key techniques, for example a digital signature and/or a secure connection. Diffie-Hellman protocols use a Diffie-Hellman key exchange to establish a shared key, then use fast symmetric algorithms for secure communication. Diffie-Hellman protocols include HTTPS for secure connection to a webserver and protocols for virtual private networks (VPNs).

Summarised, public key systems enables a central system to verify the origin of the fee data, and that the fee data are not altered in transit. In addition, the data may be encrypted for confidentiality. Data sent in the opposite direction have similar confidentiality and nonrepudiation. In addition, public key systems were originally designed to remove the need for a central register of private keys and associated costs, and still provide this benefit.

A system is considered secure if the effort to break the system exceeds the expected gain, and longer keys require more time and effort to break than shorter keys. Relatively short keys, e.g. 160-256 bit, would probably make the effort required to forge fee data much greater than the total fees charged to an associated vehicle, so the system is easily protected against fraud and eavesdroppers with limited resources.

State-level adversaries have larger resources and are expected to attack any system. For example, in 2015 a group of computer scientists reported that just a few prime numbers protect a large number of servers on the Internet. The group estimated that breaking one 1024-bit prime would allow eavesdropping on 18% of the top million HTTPS domains, and that breaking a second such prime would allow eavesdropping on connections to 66% of VPN servers. The cost of breaking one 1024-bit prime was estimated to 100 million USD. Published NSA leaks indicate that the agency's attacks on VPNs are consistent with such a break. For details, see https://weakdh.org or Adrian et al.: “Imperfect Forward Secrecy: How Diffie-Hellman Fails in Practice”, 22nd ACM Conference on Computer and Communications Security (CCS '15), Denver, Colo., October 2015.

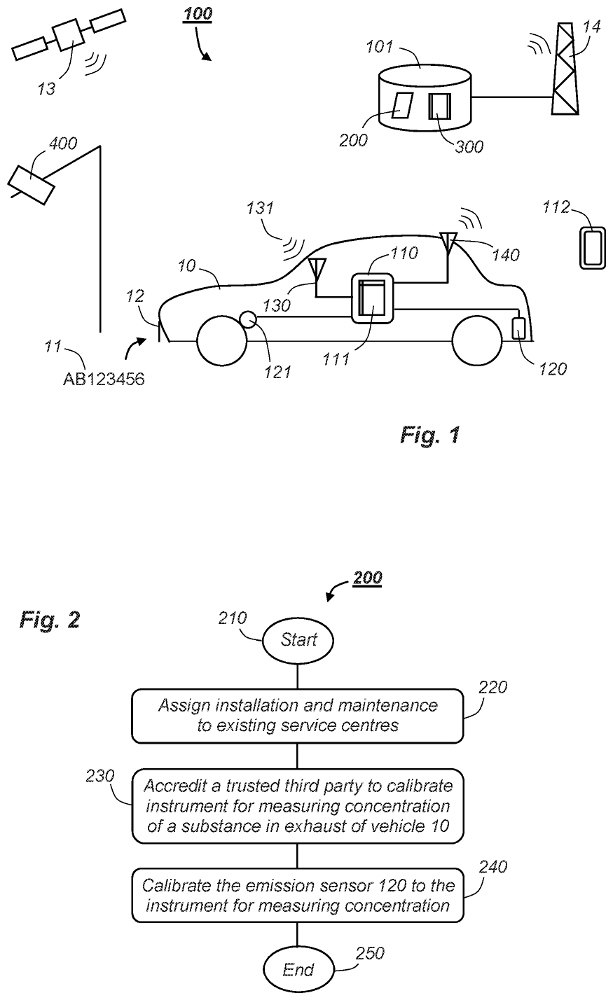

FIG. 1 illustrates a system 100 according to the invention. The main parts of the system 100 is a central system 101 with a dataset 200 and associated functions 300, a secure device 110 mounted in a vehicle 10, a terminal 112 for displaying fees or for maintenance, an emission sensor 120, an odometer 121, a PS-receiver 130 and a public network transceiver 140. The secure device 110 comprises an internal secure filesystem 111 to store data from the subsystems 120, 121, 130, and is required to authenticate origin and ensure integrity of any output message containing fee data. As noted, this may be done by providing the message with a digital signature and/or by establishing a secure connection using a Diffie-Hellman protocol. Both alternatives require a private key stored safely in the secure device 110 and a corresponding public key.

The secure device 110 should be associated with the vehicle 10 and the vehicle owner responsible for paying the fees. In a general system involving an individual and an administration, nonrepudiation typically involves holding the individual responsible for any use of an account. For example, a credit card company will hold a card holder responsible for any use of an associated card unless the credit card is reported lost or stolen. In the proposed system 100, general nonrepudiation may be achieved in a similar manner by requiring the vehicle owner to report a lost or stolen secure device 110 and maintaining a list of lost or stolen secure devices 110 in the central system 101. Automatic toll stations 400 capable of recognising a registration number 11 from a license plate 12 attached to the vehicle 10 may provide additional verification the secure device 110 belongs to the vehicle 10.

Preferably, fee data should be combined by the secure device 110. For example, dust from tarmac abrasion may reduce air quality in some areas. Vehicles with studded tires generally produce more dust than vehicles without studded tires, and are hence eligible for an extra fee. Current systems charge a fixed fee for a certain period regardless of usage. In contrast, the secure device 110 may receive a fee rate from the central system 101 depending on whether the vehicle 10 has studded tires or not, a recorded mileage from an odometer 121 and area information from a positioning system 13, 130. The secure device 110 might then compute a fee reflecting that one vehicle with studded tires may contribute less to the dust pollution than another heavily used vehicle without studded tires.

Alternatively, the secure device may simply collect usage data and forward them to the central system 101 for further processing. However, this would require a larger and more expensive central system 101 and a potential waste of computing resources in secure devices 110 otherwise capable of executing cryptographic algorithms.

In general, the secure device 110 may contain fixed and variable data. This includes any fixed datum relevant to charging a fee for use, e.g. the vehicle's registration number, brand, function, weight, motor type and power, etc. The fixed data preferably also includes fee rates, which multiplied by appropriate usage data provide the fee data. For example, a small car may be eligible for lower fee rates than a large vehicle, and a car for private use may be eligible for other fees than an ambulance, a police car or a fire truck, which might have a fee rate of zero.

In another example, zero-emission vehicles are exempted from a toll, e.g. when passing the toll station 400. In this case, the type of vehicle might conveniently be stored in the secure device 110 such that some fees will not be charged when the vehicle 10 passes the toll station 400.

The secure device 110 may be implemented by a smart card similar to those used in financial cards and SIM-cards for mobile devices. Specifically, a smart card includes a microprocessor suitable for combining fee data and executing current algorithms, e.g. SHA-2, SHA-3 and AES. The smart card also includes a secure file system 111 for storing fee rates, usage data, a private key, the registration number 11 of the associated vehicle 10 and other data as desired. The microprocessor and filesystem 111 are implemented on a chip embedded in a card substrate such as PVC or paper. Any attempt to remove the chip from the substrate requires time and skill to avoid destroying the chip. Eight gold-plated terminals on the surface of the smart card provide contact with a reader. Some of these contacts supply power and a clock signal to the chip, and other contacts are used for communication between the reader and the smart card. By design, there is no way of retrieving the private key from a smart card through the terminals. Smart cards are commercially available, standardised and need no further description herein.

Alternatively, the secure device 110 may be implemented on a purpose built chip with small footprint and low power consumption, e.g. to reduce manufacturing and operational cost. So-called lightweight cryptographic primitives include block ciphers PRESENT and HIGHT, both of which have been implemented in an FPGA. Lightweight stream encryption is also available.

In theory, the secure device 110 could also be implemented as an upgrade to existing computer systems already present in many vehicles. However, the design of these systems are largely unknown, and vehicle manufacturers may hesitate to disclose details regarding their proprietary hardware or software.

The terminal 112 presents fee data stored in the secure device 110 to a vehicle owner for verification. The terminal 112 can be, for example, a console display mounted in the vehicle 10 and/or a smart phone, a tablet, laptop or PC belonging to the vehicle owner. The terminal 112 also represents an input device for maintenance, updating fee rates etc., e.g. a computer in a car service centre. Suitable connections between the secure device 110 and the terminal 112 include wired connections, e.g. RS232 serial interface or USB, and wireless connections over a personal area network such as WiFi or Bluetooth. Either way, fee data presented to the terminal 112 should be digitally signed or otherwise protected by the secure device 110 for nonrepudiation as described above.

As briefly discussed above, the fee data may contain private data, e.g. location data, mileage etc. that should be kept confidential. At the same time, the software on the terminal should facilitate verification, comparison with historic data, allow submitting a summary without sending a detailed list etc. These objectives may be achieved in part by encrypting fee data stored in the terminal 112. In addition, the software should preferably be designed using accepted principles for secure software design. So-called “trusted chain” provides an example of how to build flexible layers of software with defined access to resources such as the secure device 110 or a communication socket.

The main purpose of the sensor module 120 is to provide real-time data on emission, in particular concentrations of certain chemical substances or substances independent of how the vehicle is used.

An emission sensor is superfluous in zero-emission vehicles, e.g. vehicles powered by a battery or a fuel cell. For other vehicles, the emission data are preferably selected from a group comprising concentrations of soot, carbon oxides (CO, CO₂), nitrogen oxides (NOx) and sulphur oxides (SOx). All of these pollute locally and globally, and may be eligible for a fee according to the principle polluter pays.

In particular, the emission sensor 120 should measure instantaneous concentrations of one or more of these substances and provide an emission value acquired over a period to the secure device 110. The period may have any suitable duration, e.g. ranging from a fraction of a second to a month or longer. A concentration is a measurable quantity, and an associated sensor may hence be calibrated by measuring a well defined parameter. In security terms, this extends nonrepudiation to the emission sensor, i.e. measuring concentration ensures that the secure device 110 and other parts of the system 100 are not used to protect garbage data from an unreliable source.

In contrast, emission might be estimated from the vehicle's mass, speed, acceleration and other parameters. Some car computers already include such models to display an “emission”. However, the origin of data remain unknown unless the manufacturer discloses a detailed model. Even then, the validity of the model is difficult to verify under all conditions and for all drivers, and there is no guarantee that the manufacturer uses the documented model in a real vehicle. After all, the manufacturer has an interest in emission, and may be suspected for manipulation. In this context, the term “may be suspected” means exactly that, and does not imply that any manufacturer actually would manipulate the model or output data. From a security perspective, the estimated emission data lack nonrepudiation because the origin of data is unknown, authenticity is difficult to establish and integrity is hard to verify.

The secure device 110 may conveniently receive a fee rate for each substance from the central system 101, and compute an appropriate fee as the fee rate multiplied by the accumulated emission of the substance.

There is a theoretical possibility for cutting the connection from the emission sensor 120 to the secure device 110 to insert a device in an attempt to save emission fees. However, such tampering would probably be detected during a service or a mandatory vehicle control. The risk for being caught, or alternatively the effort needed to hide the tampering, may easily be made greater than the expected gain from forging emission data.

Some embodiments of the system 100 comprises a PS-receiver 130, i.e. a receiver for a positioning system. Such receivers may compute a position from timing differences in signals 131 sent from several satellites 13 in a global satellite based system, currently NAVSTAR GPS or GLONASS. Such receivers 130, e.g. GPS receivers, are already installed in many vehicles, and may be connected to the secure device 110. Other positioning and navigation systems, e.g. LORAN-C, compute a position from similar time differences in signals from antennas on the ground. In some regions, e.g. the US, LORAN-C is upgraded to become a backup system for GPS. The PS-receiver 130 may receive signals 131 from any relevant positioning system.

The purpose of the receiver 130 is to provide positioning data for charging purposes, e.g. by recording when the vehicle 10 enters or leaves certain areas with different fee rates. As noted above, one or more visits to a certain area is private information that may be misused. If a PS-receiver 130 is used, i.e. as opposed to a toll station 400 that does not pass data to the secure device 110, the data may be provided as a specified list on the terminal 112 for verification. The detailed list is not required for charging purposes. Rather, a non-specified total fee should suffice as long as the origin of data is known and data cannot be manipulated in transit from the secure device 110. Never transmitting detailed information from the secure device 110 or the terminal 112 reduces the potential for misuse.

Some embodiments comprise a radio transceiver 140 connecting the secure device to a public communication network represented by antennae 14 at the central system 101. The public network 14 would typically be a cellular network for mobile devices, e.g. GSM, 3G, 4G etc., as transceivers for such networks are readily available, relatively inexpensive and suitable for communicating with a moving vehicle 10.

In embodiments with a transceiver 140, the secure device 110 may sign a message digitally and/or use a Diffie-Hellman protocol to establish a secure connection to the central system 101, then send fee data directly to the central system 101. The central system 101 may send fee rates and other information in a similar manner in the opposite direction.

Later, the automatically sent fee data may be available for the vehicle owner on a secure website for verification and approval. In this case, a web browser, e.g. running on the terminal 112, would typically establish a secure HTTPS-connection to the website, i.e. use a Diffie-Hellman protocol. The vehicle owner may be assumed to approve any data in the system 101 when a time limit expires, i.e. by silent consent if no data are corrected. This is similar to an existing system for collecting taxes in Norway. A system 100 perceived to use current technology and enabling the vehicle owner to correct data is likely to be considered fair and efficient. If private data are deleted from the dataset 200 once the fees are charged, the central system 101 should also comply with most privacy regulations.

The opportunity to review and approve detailed data on a secure website provides an alternative to a dedicated software application running on the terminal 112. In both cases, a private key securely and safely stored in the secure device 110 and an associated public key provides nonrepudiation, i.e. origin, integrity etc. of the fee data. Thus, a personal certificate issued to the vehicle owner and installed on the terminal 112 is not required for the proposed system, but may be desirable for other purposes. Some applications, e.g. running in a web browser, may use certificates to authenticate a contact, e.g. a secure website, before establishing a secure connection. Thus, while certificates and other known tools may be used with the system 100, they are not part of the system 100 and need no further explanation here.

The automatic toll station 400 may comprise a reader capable of reading an RFID-tag mounted in the vehicle. A typical toll station 400 records the time when a vehicle enters a toll road or is otherwise eligible for a fee, but not the time when the vehicle exits the toll road or area. Thus, a toll station 400 is useful for charging a fixed fee, perhaps depending on defined periods such as rush hour or days with high pollution in the defined area. The proposed system 100 adds an ability to charge a fee depending on time spent and/or distance driven in the defined area.

Some toll stations 400 may be configured to recognise a registration number 11 from a license plate 12 attached to the vehicle 10. Such toll stations 400 may provide an extra authentication of the secure device 110 within a vehicle 10 and thus enhance the general nonrepudiation as briefly described above. The proposed system 100 does not necessarily add significant cost or administration to existing toll systems.

FIG. 2 illustrates steps in a method 200 according to the invention.

Step 210 involves any preparation for using the system 100 described above, e.g. reallocating resources from an existing system for charging a fixed fee to the central system 101.

Step 220 involves assigning installation and maintenance of the secure device 110 and associated subsystems 120, 130, 140 to a service centre for vehicle maintenance. This is mainly for practical reasons, as existing service centres may install and maintain secure devices 110, emission sensors 120 and other parts of the system 100 during normal service or mandatory vehicle controls. In addition, the general public, vehicle manufacturers and authorities will realise that an attempt to manipulate numerous service centres is likely to become public, e.g. in the press or in social media, and hence that it is unlikely that someone would try to manipulate a significant amount of service centres. In turn, this may increase public confidence in the system 100 according to the invention.

Step 230 includes accrediting a trusted third party to calibrate an instrument for measuring emission in the exhaust of a vehicle. A trusted third party is a common measure to remove unfounded suspicion from interested parties, here the vehicle owner, the vehicle manufacturer and the authorities responsible for charging the fees. The proposed method 200 has a similar purpose. The trusted third party would typically be a company accredited for calibration in other fields of industry.

The instrument for measuring concentration of a substance in the exhaust of the vehicle 10 is specifically an accurate sensor at the service centre and measures concentration of soot, CO, CO₂, NOx and/or SOx in the exhaust. A concentration of a well defined physical chemical substance may be measured without any assumption of the vehicle's speed, acceleration etc., and hence does not depend on how the vehicle is used. This validates the emission data input to the secure device 110 as explained above.

In step 240, each service centre calibrates the emission sensor 120 to the instrument for measuring emission. Specifically, the service centre would use the terminal 112 to adjust the output from emission sensor 120 to match a measured value provided by the more trusted and accurate instrument.

The method ends in step 250, e.g. at the end-of-life for the system 100.

The method 200 excludes the vehicle owner, the manufacturer of the vehicle and authorities responsible for charging the fees from calibrating test equipment and the emission sensors 120. Hence, neither of these parties may be suspected for manipulating emission rates or fees out of self-interest.

While the system and method has been described by means of example, numerous alternatives and additions will be apparent to those skilled in the art. The full scope of the invention is set forth in the accompanying claims.

1-13. (canceled)

14. A system for charging fees for a vehicle comprising:
a central system;
a secure device mounted in the vehicle and configured to receive, process and store fee data as well as to provide nonrepudiation for all output fee data.

15. The system according to claim 14, further comprising a terminal for verifying and approving fee data.

16. The system according to claim 14, further comprising an emission sensor placed in the exhaust of the vehicle and configured to provide real-time emission data to the secure device.

17. The system according to claim 14, further comprising an odometer configured to provide a mileage to the secure device.

18. The system according to claim 14, further comprising a PS-receiver for providing positioning data to the secure device.

19. The system according to claim 14, further comprising an automatic toll station for recording a time at which the vehicle passes.

20. The system according to claim 19, wherein the automatic toll station is configured to recognise a registration number from a license plate attached to the vehicle.

21. The system according to claim 14, further comprising a radio transceiver for connecting the secure device to a public network.

22. The system according to claim 14, wherein the secure device is configured to encrypt fee data.

23. The system according to claim 22, wherein the central system comprises a blacklist of lost or stolen security devices.

24. A method for charging fees for a vehicle, the method comprising:
using the system according to claim 13; and
assigning installation and maintenance of the secure device and associated sub systems to a service centre for vehicle maintenance.

25. The method according to claim 24, further comprising the step of accrediting a trusted third party to calibrate an instrument for measuring concentration of a substance in the exhaust of the vehicle.

26. The method according to claim 25, further comprising the step of calibrating the emission sensor to the instrument.
